(19) United States
(12) Patent Application Publication
(10) Pub. No.: US 2026/0000213 A1
(43) Pub. Date: Jan. 1, 2026

(54) BEDDING CLIP AND METHOD OF USE

(71) Applicant: Lloyd J. Stokes, Bothell, WA (US)

(72) Inventor: Lloyd J. Stokes, Bothell, WA (US)

(21) Appl. No.: 18/761,072

(22) Filed: Jul. 1, 2024

Related U.S. Application Data
(60) Provisional application No. 63/463,549, filed on May 2, 2023.

(51) Int. Cl. A47C 21/02; F16B 2/00; F16B 2/10

(52) U.S. Cl. CPC A47C 21/02; F16B 2/005; F16B 2/10

(57) ABSTRACT

A bedding clip is provided that includes a pair of bodies that are substantially identical, each having a blade portion and a handle portion, with a hinge assembly formed on a front face of the blade portion that engages the hinge assembly of the other of the pair of bodies to form a working hinge configured to permit the one body to rotate about the working hinge relative to the other between an open and a closed position. Latching elements formed on the handle portions of the bodies engage each other in the closed position and pluralities of teeth formed the blade portions interleave while in the closed position. The bedding clip is sized and configured to be attached to bedding and to prevent the bedding from becoming untucked from a bed during use.

Typically, a made bed includes a mattress resting on an underlying support, such as a platform or a box spring, etc. A flat or fitted sheet is usually wrapped over four sides of the mattress and a second, flat, sheet wrapped over three sides of the mattress with a fourth side left open at the “top” to permit a person to lie between the two sheets. Depending upon the anticipated nighttime temperature and the user's preferences, a light or heavy blanket may be laid over the sheets and wrapped over the same three sides, and perhaps a spread of comforter laid over the whole. Pillows are usually positioned at the top end for the user's head to rest upon. Of course, the variations on this basic plan are numerous and well known.

A problem that many people experience with this arrangement is the difficulty in keeping the bedclothes tucked around and beneath one, two, or three of the sides of the mattress. If a person has a tendency to move about during the night it is common for the bed clothes to pull out from between the mattress and the underlying support, creating some discomfort for the occupant(s).

### BRIEF DESCRIPTION OF THE DRAWINGS

FIG. 1 is a perspective view of a bedding clip jaw, according to an embodiment.

FIG. 2 is a perspective view of a bedding clip comprising a pair of bedding clip jaws similar to the bedding clip jaw of FIG. 1, in an open position, according to an embodiment.

FIG. 3 is a perspective view of the bedding clip of FIG. 2, in a closed position.

FIG. 4A is a diagrammatic side view of a bed incorporating a bedding clip similar to the bedding clip of FIGS. 2 and 3, according to an embodiment.

FIG. 4B is a detailed view of a portion of the bed of FIG. 4A, according to an embodiment.

FIG. 5 is a diagrammatic plan view of the bed of FIG. 4A, showing an arrangement of multiple bedding clips, according to an embodiment.

FIG. 6 is a plan view of a portion of a bedding clip jaw according to another embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

In the drawings, a reference number followed by a letter, e.g., “203a, 203b,” is used where it may be useful in the corresponding description to refer to or differentiate between specific ones of a number of otherwise similar or identical elements. Where the description omits the letter from a reference, and refers to such elements by number only, this can be understood as a general reference to the elements identified by that reference number, unless other distinguishing language is used.

Principles of the invention, aspects of which are defined in the appended claims, are illustrated in the exemplary embodiments described hereafter.

As used herein, the term bedding refers to bedclothes that may be used on a bed, including, e.g., one of or a combination of sheets, blankets, comforters, spreads, quilts, etc.

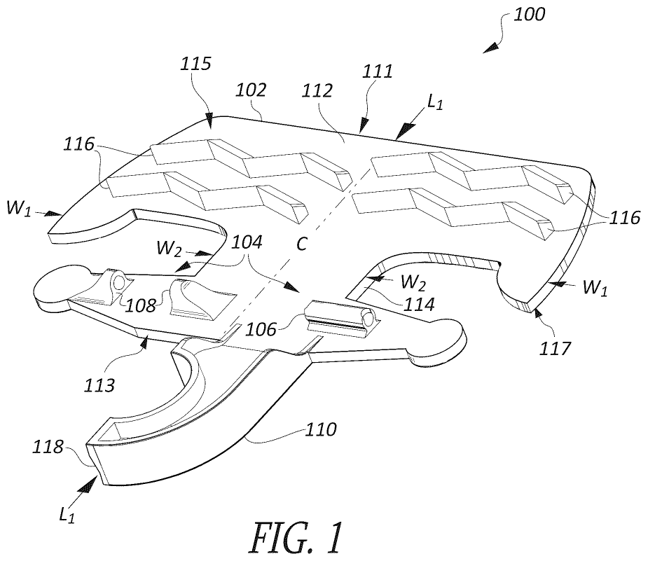

FIG. 1 is a perspective view of a bedding clip jaw 100, according to an embodiment. The jaw 100 includes a body 102 including a handle portion 110 and a blade portion 112. The blade portion 112 includes a front edge 111, a back edge 113, a front face 115, and back face 117. The handle portion 110 is coupled to the blade portion 112 along the back edge 113 of the blade portion. A hinge assembly 104 is formed on a front face 115 of the blade portion 112 near the back edge 113 of the blade portion 112 and includes a male element 106 and female elements 108. A plurality of teeth 116 are formed on the front face 115 of the blade portion 112 of the body 102 with teeth on the left side of the body (as viewed in the drawing) offset from teeth on the right side such that the plurality of teeth cooperate with teeth from a second jaw, as will be described in more detail below. In the embodiment shown, the blade portion 112 of the body 102 includes a narrow region 114 between the hinge assembly 104 and the plurality of teeth 116. Additionally, the handle portion 110 of the body 102, which includes a latching element 118, is positioned entirely on one side of a longitudinal center line C of the body—the right side, as viewed in FIG. 1, in the embodiment shown.

Some dimensions of the body 102 may, in various embodiments, be selected to modify particular characteristics of the body, as will be discussed below with reference to later figures. In the embodiment shown in FIG. 1, dimensions of the body 102 include a length L₁, a width W₁ of the blade portion 112, and also a width W₂ of a narrow region 114 of the blade portion.

According to various embodiments, the length L₁, is within a range of about 4″ to 8″ and the width W₁ of the blade portion 112 is within a range of about 4″ to 8″. In embodiments that include a narrow region, the width W₂ of the narrow region 114 is within a range of about 1.5″ to 3.5″. The overall shape of the body 102 is a design choice and can be selected for utilitarian and/or fanciful reasons, according to the requirements of a particular application. In the embodiment shown, the overall shape is that of a stylized ship anchor, for ornamental purposes.

According to one embodiment, the bedding clip 200 has a width W₁ of about 6.5″ and a length L₁, of about 5.5″.

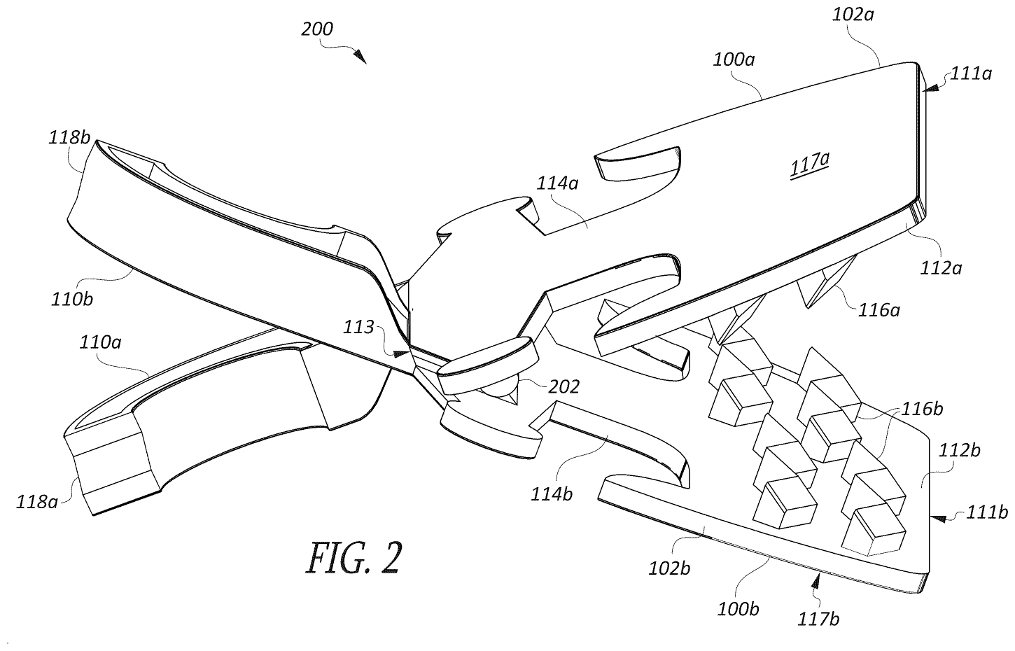

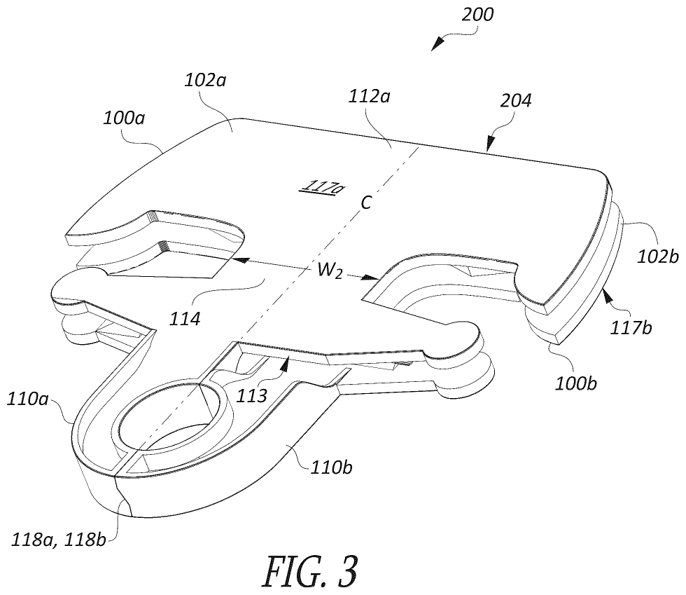

FIGS. 2 and 3 are perspective views of a bedding clip 200, according to an embodiment, comprising a pair of bedding clip jaws 100a and 100b, which are substantially identical to each other and similar to the bedding clip jaw 100 of FIG. 1.

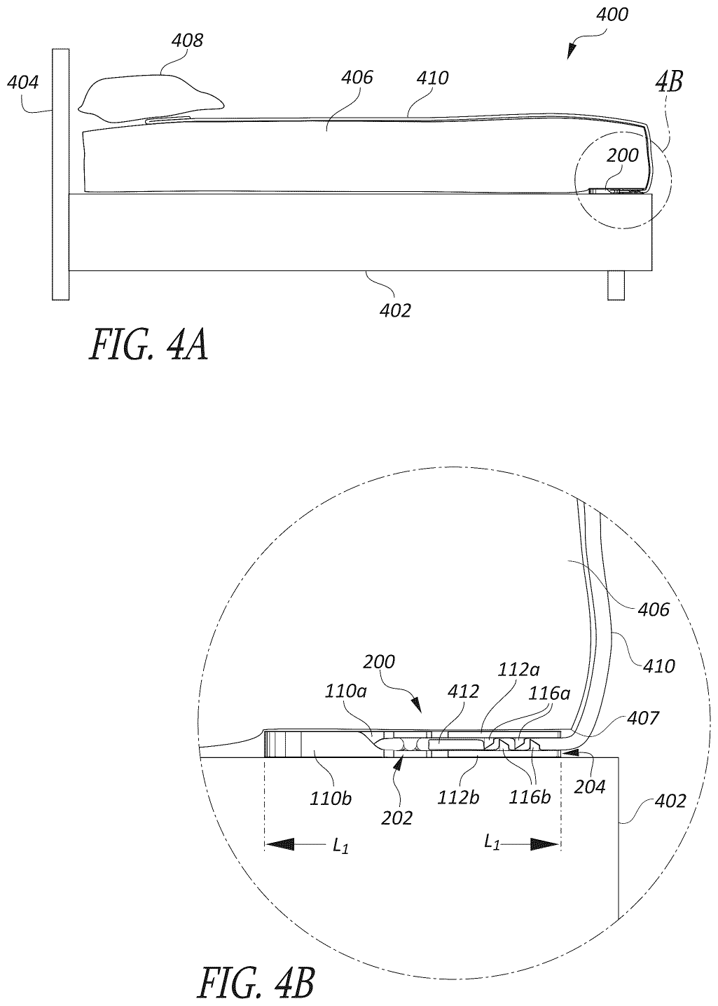

The bedding clip jaws 100a, 100b are oriented facing each other, with their respective pluralities of teeth 116a, 116b facing each other. In this arrangement, the respective male elements 106 of the hinge assemblies 104 of each of the bedding clip jaws 100a, 100b are positioned to engage the corresponding female elements 108 of the opposing bedding clip jaw to form functional hinges 202 around which the bedding clip jaws 100a, 100b are rotatable, relative to each other. In FIG. 2, the bedding clip 200 is shown in an open position, in which the respective blade ends 112a, 112b and handle ends 110a, 110b are separated, with the blade end 112a lying “above” a plane defined by the blade end 112b and the handle end 110a lying “below” the same plane. FIG. 3 shows the bedding clip 200 in a closed position, in which planes defined by the respective blade ends 112a, 112b lie approximately parallel to each other, with teeth 116a, 116b interleaved (see FIG. 4B) and the front edges 111a, 111b of the blade portions 112a, 112b together forming a front edge 204 of the bedding clip 200. Additionally, with the bedding clip 200 in the closed position, the respective latching elements 118a, 118b are releasably engaged, or locked, in a snap-fit engagement, releasably holding the bedding clip 200 in the closed position. While in the closed position, the bedding clip 200 lies between parallel planes defined by the back faces 117a, 117b of the respective bedding clip jaws 100a, 100b.

As shown on FIG. 3, according to an embodiment, while the bedding clip 200 is in the closed position, the handle ends 110a, 110b define between them a closed loop, or aperture 206 that extends through the bedding clip 200. The loop 206 can be used as an anchor element, in the event a user wishes to secure the clip in position, or a hanging point, from which the bedding clip can be hung for storage or display, etc. When the bedding clip 200 is rotated to the open position, the loop 206 opens, which enables simple engagement and disengagement of the loop with another element.

The bedding clip 200 can be manufactured using any appropriate process and material. During development, the inventor used a 3-D printing process to manufacture prototypes from nylon resin. While the bedding clip 200 can of course be manufactured by injection molding processes, from any of a number of plastics, including nylon, acrylic, polycarbonate, etc., the selection of a particular process and material is a design choice that may be influenced by the cost and availability of materials, manufacturing facilities, tooling, and labor, the particular intended use of the clip, etc.

In operation, according to an embodiment, with bedding positioned on a bed according to a user's preference, i.e., in a selected arrangement on the bed, the user positions a bedding clip 200, while in the open position, adjacent to the bedding such that an edge of the bedding is between the blade ends 112a, 112b, then moves the clip to the closed position, capturing the edge between the blade ends, with the respective pluralities of teeth 116a, 116b firmly engaging the edge of the bedding, and engaging the latching elements 118a, 118b of the bedding clip jaws 100a, 100b, holding the bedding clip in the closed position. If necessary or desired, the user can fold the bedding to effectively shorten the bedding along one or more sides and form an edge at a more advantageous location. The user then tucks the edge of the bedding, with the bedding clip 200 attached, between the mattress of the bed and the underlying support of the mattress, such as a bed spring element or platform. During use of the bed, the clip 200 prevents the bedding from being pulled from under the mattress, as explained in more detail below with reference to FIGS. 4A, and 4B.

FIG. 4A is a diagrammatic side view of a bed 400 incorporating a bedding clip 200 similar to the bedding clip 200 of FIGS. 2 and 3, according to an embodiment. FIG. 4B is a detailed view of a portion of the bed 400, indicated at 4B of FIG. 4A, according to an embodiment. The bed 400 includes a bed frame or platform 402, a headboard 404, a mattress 406 with a bottom edge 407, a pillow 408, and bedding/bed clothes 410, such as, e.g., a top sheet and a light blanket, etc. Other elements of a typical bed are not shown but are presumed to be present, according to the preferences and requirements of a particular user. Such elements can include, for example, a fitted bottom sheet, a bed spread, one or more heavy blankets and/or quilts, a spring element beneath the mattress, etc.

The term bottom edge is used herein to refer to the transition line, or corner, between the bottom, substantially horizontal face of a mattress and any of its substantially vertical side faces.

The bedding clip 200 is positioned between the mattress 406 and the platform or substrate 402, with an edge portion 412 of the bedding 410 gripped firmly between the blade ends 112a, 112b of the bedding clip jaws 100a, 100b. Referring, in particular to FIG. 4B, it can be seen that upward tension on the bedding 410, as might be applied by a user while occupying the bed 400, will tend to pull the edge portion 412 of the bedding, along with the bedding clip 200, out from between the mattress 406 and the platform 402, i.e., toward the bottom edge 407. However, once the front edge 204 of the bedding clip 200 is approximately in line with the bottom edge 407 of the mattress 406, further movement is prevented because the rigid bedding clip won't flex around the bottom edge of the mattress and the length L₁ of the bedding clip is such that a typical mattress cannot be sufficiently compressed as to permit the clip to be pulled directly upward from this position. Thus, the bedding 410 does not become untucked but is retained under the mattress 406.

In a case where the mattress 406 is particularly soft and compressible, strong upward tension on the bedding 410 might apply sufficient upward force on the bedding clip 200 as to compress the edge of the mattress, permitting the clip to tilt upward until it reaches an angle that allows it to slide from beneath the mattress, but in the inventor's experience, this would require far more force than would normally be applied to the bedding. Nevertheless, if such an occurrence is a concern, it can be prevented, according to an embodiment, by the provision of a bedding clip 200 with a greater length L₁. The inventor has found that a length L₁ of around 4″ or 5″ inches is sufficient for most mattresses but envisions longer clips for use with particularly soft mattresses. The width W₁ of the blade ends 112 of the jaws 100 of the bedding clip 200 can be selected to provide a desired degree of gripping strength, while distributing the grip across an area sufficient to prevent potential damage to bedding under normal conditions. According to an embodiment, the narrow regions 114 of the bodies 102 of the bedding clip 200 provide a degree of flexibility to the respective jaws 100, permitting the bedding clip to firmly grip relatively thin bedding, such as a single sheet, for example, while also being able to flex, somewhat, to accommodate thicker bedding, such as a sheet and one or more blankets, etc., without causing damage to the bedding clip. The dimensions of the narrow regions 114, including the width W₂, can be selected to provide a desired degree of flexibility, which of course will also be influenced by the choice of material used. Other embodiments are envisioned in which the narrow region 114 is omitted.

According to various embodiments, other parameters can also be modified to modify corresponding characteristics. These can include control of various other dimensions, selection of the particular material from which the clip is formed, etc. Selection and control of such design features is within the abilities of a person having ordinary skill in the art.

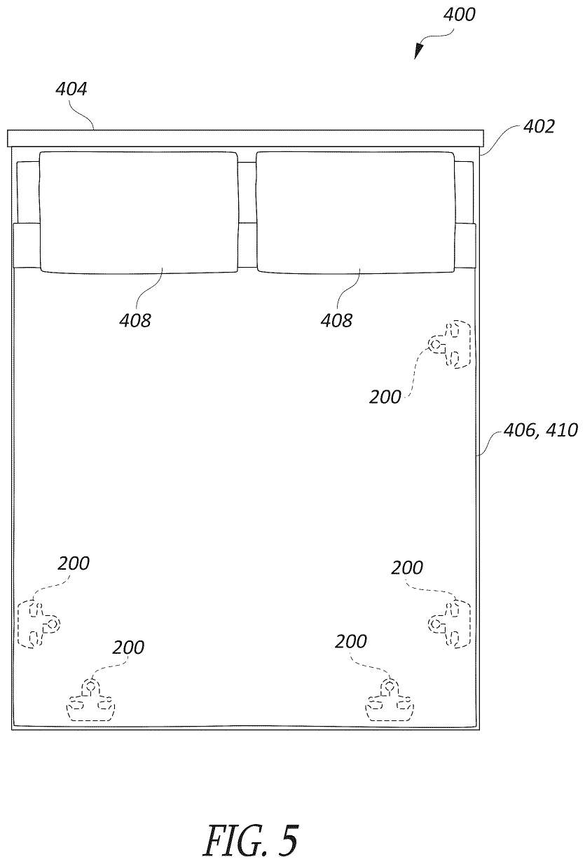

FIG. 5 is a diagrammatic plan view of the bed 400 of FIG. 4A, showing locations of multiple bedding clips 200, according to an embodiment. In the embodiment shown, bedding clips 200 are positioned to prevent the bedding 410 from being pulled out along the bottom and right side of the bed 400, while on the left side there is no clip positioned on the upper part of the bedding. This permits a user to separate the bedding from the mattress and any underlying sheet, etc., along the upper left side in order to enter and exit the bed. Of course, the number of bedding clips 200, and their positions, can be arranged in different configurations to accommodate multiple occupants, larger or smaller beds, and the particular preferences of the user. Additionally, some of the bedding clips 200, such as, e.g., the clips along the sides of the bed 400, can be positioned to grip the bedding at a deeper position, i.e., further inward from the edges of the mattress 406 so that more of the bedding 410 can be pulled from between the mattress and the platform 402 before the corresponding bedding clips 200 reach the bottom edges of the mattress and prevent any further bedding from being untucked, thus providing some available slack for the comfort of the occupant(s).

According to an embodiment, bedding clips are provided only along the foot of the bed, to prevent the bedding from becoming untucked there, while permitting unrestricted access to the bed from both sides.

According to an embodiment, a user positions the bedding over the bed in a preferred arrangement, i.e., the arrangement that the user wishes the bedding to be in when the bed is “made” but with the sides of the bedding hanging vertically from the top of the mattress. The user then folds a portion of the bedding along the foot or one side back onto the top of the bed. The user places a second fold in the bedding, approximately parallel to the one side of the bed—allowing for the thickness of the mattress and any desired degree of available slack—to define a new functional edge of the bedding. The user then attaches one or more bedding clips along the new edge of the bedding, then folds that portion of the bedding back down over the side of the bed and tucks the portion of the bedding, along with the one or more attached bedding clips, between the mattress and the underlying substrate. The position of the second fold in the bedding defines a maximum depth from a nearest edge of the mattress at which the bedding clips can be positioned, such that when the bedding clips are tucked under the mattress at this depth, with the bedding in the preferred arrangement, the bedding is held neatly taut along that part of the bed.

If desired, the user may repeat this process along one or more additional sides of the bed until the bedding is configured according to the preferences of the user. When the bed is occupied, the bedding clips permit a prescribed amount of slack in the bedding, as previously described, while preventing the bedding from being entirely pulled from under the mattress. When the user wishes to remake the bed, it is a simple matter to push the bedding clips, with the attached edges of the bedding, back under the mattress to their original positions, significantly simplifying the task of remaking the bed.

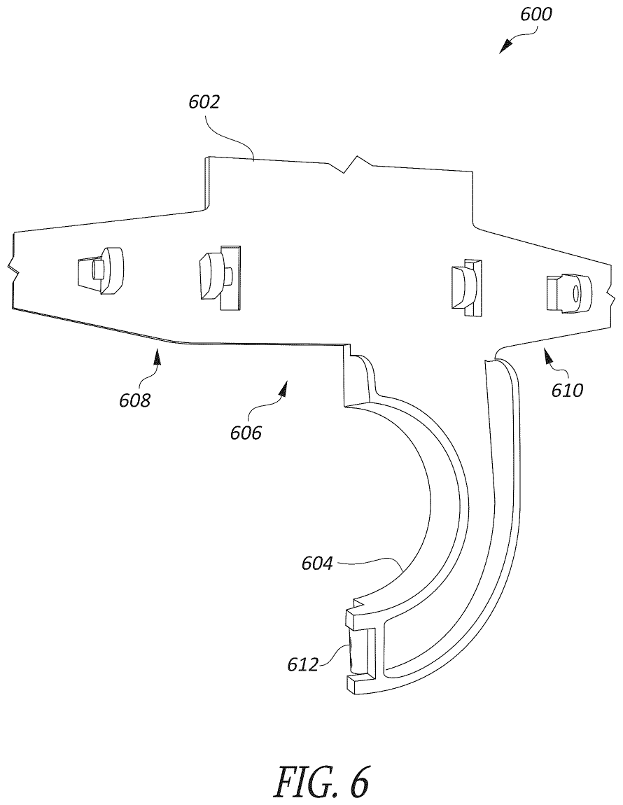

FIG. 6 is a plan view of a portion of a bedding clip jaw 600 according to another embodiment. The bedding clip jaw 600 includes a body 602 with a handle portion 604. The bedding clip jaw 600 includes elements that are optimized for injection molding processes, such as a hinge assembly 606 with male elements 608 and female elements 610, and a locking element 612 on the handle portion 604. Of course, the male elements 608 of the hinge assembly 606 are configured to engage the female elements 610 of the hinge assembly of a second bedding clip jaw 600 to form a functional hinge, as previously described. Other features of the jaw 600 are substantially similar to features and elements previously described with reference to other embodiments, with similar operating principles.

The inventor has identified some problems with prior art bedding retaining systems, in particular the problem that in most cases that employ anchors of one type or another, the prior art anchors tend to be pulled from their position under forces that are commonly applied to bedding during use. Many prior art systems that are intended to address this problem require the provision of a structure under or around a mattress to which the anchors can be attached. By providing a bedding clip that is larger in size than prior clips, and particularly having a greater length, the inventor has found that such problems can be largely eliminated, or at least mitigated. Other features provide additional advantages, many of which are also described herein.

While embodiments are described herein with reference to their use in retaining bedding on a mattress, other uses are also envisioned. For example, according to an embodiment, a pair of bedding clips can be used to hang textiles, such as quilts, rugs, tapestries, etc., for display or storage. In such other embodiments, the dimensions of the bedding clip may be selected to be smaller or larger than those described above, as appropriate for the intended use.

The inventor has identified a number of benefits and advantages provided by various embodiments, some examples of which include the following: Referring to the bedding clips described with reference to FIGS. 2 and 3 (and similar embodiments), the jaws 100a, 100b are substantially identical and so a single manufacturing process can be repeated to make both. This reduces the cost and complexity of manufacture and assembly. Additionally, the jaws can be designed to snap together for simplified assembly. The embodiments shown above are provided with a latching element (118), which eliminates the need of a spring to apply closing force, reducing the part count and cost, and further simplifying assembly. When in the closed position, the bedding clip of many embodiments is essentially flat, without portions that protrude and that might damage or distort a mattress. The flat shape also enables compact stacking of a plurality of clips for storage or packaging.

The inventor has recognized that, ordinarily, the underside of a mattress is substantially flat and featureless and is positioned on a substantially flat and featureless underlying surface. Thus, a problem with systems intended to prevent bedding from being pulled from under the mattress is that there is no ready feature to which a sheet-edge may be anchored. The inventor is aware of various strap-and-clip combinations intended to be attached to adjacent edges of a sheet with a strap extending diagonally under a mattress corner, effectively using one edge of a sheet to anchor the adjacent edge. A problem with such systems is that they are typically limited to the portions of a sheet near a mattress corner. Additionally, they require that two edges be anchored, i.e., a sheet cannot be anchored along a bottom of a mattress without also anchoring the sheet along at least part of one or both sides. They can also be relatively difficult to install. In contrast, bedding clips of the present disclosure are attached only to one edge of the bedding, without a separate anchor point required, are simple to use, and can be positioned unobtrusively and entirely under the mattress.

The various embodiments described above can be combined to provide further embodiments. Furthermore, aspects of the embodiments can be modified to employ concepts of other known devices and systems to provide yet 5 further embodiments.

These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

1. A bedding clip, comprising:
a first body having a blade portion and a handle portion, the first body including:
a hinge assembly formed on a front face of the blade portion and configured to engage a hinge assembly of an identical body and form, with the hinge assembly of the identical body, a working hinge configured to permit the first body to rotate about the working hinge relative to the identical body;
a latching element formed on the handle portion; and
a plurality of teeth formed on the front face of the blade portion.

2. The bedding clip of claim 1, comprising:
a second body, substantially identical to the first body, including a blade portion and a handle portion, a hinge assembly, a latching element, and a plurality of teeth, the hinge assemblies of the first and second bodies being engaged with each other and forming a working hinge such that the first body is rotatable, relative to the second body, between a closed position, in which the latching element of the first body is releasably engaged with the latching element of the second body, and an open position, in which the latching elements of the first and second bodies are disengaged from each other.

3. The bedding clip of claim 2, wherein the open position comprises a range of positions in which the latching elements of the first and second bodies are disengaged from each other.

4. The bedding clip of claim 2, wherein, while the first body is in the closed position, relative to the second body, a bedding clip formed by the first and second bodies lies substantially between a first plane defined by a back face of the blade element of the first body and a second plane defined by a back face of the blade element of the second body.

5. The bedding clip of claim 4, wherein, while the first body is in the closed position, relative to the second body, the first plane is substantially parallel with the second plane.

6. The bedding clip of claim 2, wherein, while the first body is in the open position, relative to the second body, the plurality of teeth of the first body are separated from the plurality of teeth of the second body, and while the first body is in the closed position, relative to the second body, the plurality of teeth of the first body are interleaved with the plurality of teeth of the second body.

7. The bedding clip of claim 2, wherein the blade portion of the each of the first and second bodies includes a narrow region between the plurality of teeth and the hinge assembly of the respective body.

8. The bedding clip of claim 7, wherein the narrow region of each of the first and second bodies imparts a degree of flexibility to the respective body that enables the blade portions of the first and second bodies to resiliently flex apart from each other while the first body is in the closed position relative to the second body.

9. The bedding clip of claim 7, wherein the narrow region of each of the first and second bodies has a width of less than half a width of the respective body.

10. The bedding clip of claim 1, wherein the first body has a length of at least about four inches and a width of at least about three inches.

11. The bedding clip of claim 2, wherein, while the first body is in the closed position, relative to the second body, the handle portions of the first and second bodies define, between them, an aperture extending through a bedding clip formed by the first and second bodies.

12. A method of securing bedding to a mattress, comprising:
positioning bedding over a mattress in a selected arrangement;
positioning a portion of the bedding between first and second jaws of a bedding clip while the bedding clip is in an open position; and
moving the bedding clip, while the portion of the bedding is positioned between the first and second jaws, to a closed position such that respective latching elements of the first and second jaws releasably engage each other and a plurality of teeth of the first jaw interleave with a plurality of teeth of the second jaw, thereby engaging the portion of the bedding between the pluralities of teeth of the first and second jaws.

13. The method of claim 12, comprising:
positioning the bedding clip between the mattress and an underlying substrate with the portion of the bedding engaged between the first and second jaws.

14. The method of claim 13, wherein the positioning a portion of the bedding between first and second jaws of a bedding clip comprises positioning, between the first and second jaws, a portion of the bedding that is a selected distance from an edge of the bedding, the selected distance being such that when the bedding clip is positioned between the mattress and the underlying substrate and the bedding is positioned over the mattress in the selected arrangement, a maximum depth from a nearest edge of the mattress is defined at which the bedding clip can be positioned.

15. The method of claim 13, comprising:
positioning a second portion of the bedding between first and second jaws of a second bedding clip while the second bedding clip is in an open position; and
moving the second bedding clip, while the second portion of the bedding is positioned between the first and second jaws of the second bedding clip, to a closed position such that respective latching elements of the first and second jaws of the second bedding clip releasably engage each other and a plurality of teeth of the first jaw of the second bedding clip interleave with a plurality of teeth of the second jaw of the second bedding clip, thereby engaging the second portion of the bedding between the pluralities of teeth of the first and second jaws of the second bedding clip.

16. The method of claim 15, comprising:
positioning the second bedding clip, while the second portion of the bedding is engaged between the first and second jaws of the second bedding clip, between the mattress and the underlying substrate.

17. The method of claim 13, wherein the positioning the bedding clip between the mattress and an underlying substrate with the portion of the bedding engaged between the first and second jaws comprises positioning the bedding clip between the mattress and an underlying substrate at a depth such that, while the bedding is positioned over the mattress in the selected arrangement, the bedding is held neatly taut, at least in the region of the bedding clip.
